(19) United States
(12) Patent Application Publication
(10) Pub. No.: US 2003/0112781 A1
(43) Pub. Date: Jun. 19, 2003

(54) Communications unit for secure communications

(76) Inventors: Roger George Kermode, Coogee (AU); Aidan Michael Williams, Chifley (AU); Henry William Peter Beadle, Chipping Norton (AU)

Correspondence Address: MOTOROLA, INC., 1303 EAST ALGONQUIN ROAD, IL01/3RD, SCHAUMBURG, IL, 60196

(21) Appl. No.: 10/024,826

(22) Filed: Dec. 17, 2001

(51) Int. Cl. H04Q 7/24

(52) U.S. Cl. 370/338; 370/419

(57) ABSTRACT

A Wireless Local Area Network Card (40) with a unit communications port (62) that permits secure transfer of information between the removable communications unit and an introduction device (22) when a proximity based communications port (66) of the introduction device (22) is placed in close proximity to the unit communications port (62). The Card (40) also has a processor (42) connected to the unit communications port (62) and there is a unit connector (52) that allows for complementary releasable engagement of a connector (54) associated with an electronic device (12). The unit connector (52) is connected to the processor (42) and allows communication between the processor (42) and the electronic device (12). A communications interface (48) is connected to the processor for allowing the Card (40) to communicate with at least one other remote Card (40). There is also a memory (44) connected to the processor (42) for storing security information, wherein in use the processor (42) communicates with the introduction device (22) to transfer the security information between the memory (44) and introduction device via the unit communications port (62) and the proximity based communications port (66).

### FIELD OF THE INVENTION

This invention relates to a secure communications. The invention is particularly useful for, but not necessarily limited to, creating federations of communications units that share security information. The units typically have a connector to allow releasable engagement and communication with an electronic device. Also the units preferably have transceivers to allow communication with each other thereby allowing communication between their respective engaged devices.

### BACKGROUND ART

There are several situations where communications between electronic devices should be restricted or encrypted. One situation is “drive by” joining of networks occurring as mobile, wireless devices come into radio range of other wireless devices. Another situation is wireless networks with overlapping coverage as could be present in an apartment block with a number of home radio networks, perhaps associated with broadband network gateways. A further situation is any shared network, wired or wireless, where you only want to exchange traffic with a subset of devices on the network. In these scenarios, the devices are using a shared network to communicate with each other. Since other devices might be sharing the network, the communications cannot be assumed to be private.

The secure configuration of wireless appliances in the presence of multiple wireless gateways that share the same spectrum is problematic since the appliances cannot determine which gateway to use without communicating outside of the wireless band. If an out of band mechanism is not present then an imposter gateway can impersonate the desired gateway, enabling it to intercept data to and from the appliance.

Cryptographic techniques can be effectively used to secure communications over the shared network, at the cost of managing cryptographic keys. Current solutions involve pre-configuring the appliances and devices using PINs or passwords to derive encryption keys or ignoring the security issues entirely. Pre-configuring security information into devices restricts the number of devices you can communicate with and is typically onerous on the consumer. Sharing PINs or passwords with all of the devices you want to communicate with is not desirable if you share the one key with every device, or it is unmanageable if each device has it's own key. Not implementing security is not acceptable for widely deployed consumer items.

It would be convenient if a group or groups of devices could share the same security information. Such groups are referred to as federations. There is a clear need for simple, secure techniques for sharing security information between networked electronic devices. Therefore, there must be mechanisms to simply and securely create federations of devices that share security information like cryptographic keys and access control information that is used to restrict communication to a subset of devices and to ensure the confidentiality of data transferred over a shared network. Typically, security information is stored in an electronic device, such as a computer, by a user typing the information directly into the device's memory. Other means of storing security information in computers are also in use. However, because the security information is stored on the computer, an authorised user of a federation must have access to a device that has security information allowing it to communicate with other federation members. It would therefore be beneficial if an authorised user of a federation could simply access the federation without having to type in the security information or finding a computer that already has the security information stored in its memory.

In this specification, including the claims, the terms comprises, comprising or similar terms are intended to mean a non-exclusive inclusion, such that a method or apparatus that comprises a list of elements does not include those elements solely, but may well include other elements not listed.

### SUMMARY OF THE INVENTION

A removable communications unit comprising:

a unit communications port that permits secure transfer of information between the removable communications unit and an introduction device when a proximity based communications port of the introduction device is placed in close proximity to the unit communications port;

a processor connected to the unit communications port;

a unit connector that allows for complementary releasable engagement of a connector associated with an electronic device, the unit connector being connected to the processor and allows communication between the processor and the electronic device;

a communications interface connected to the processor for allowing the removable communications unit to communicate with at least one other remote removable communications unit; and

a memory connected to the processor for storing security information, wherein in use the processor communicates with the introduction device to transfer the security information between the memory and introduction device via the unit communications port and the proximity based communications port.

Suitably, the unit communications port may allow the security information to be transferred from the introduction device to the memory. The unit communications port may preferably allow security information to be transferred from the memory to the introduction device.

Suitably, the communications interface may be a transmitter, receiver or transceiver.

Preferably, the communications interface may communicate with at least one said other remote removable communications unit by radio frequency signals.

Preferably, the removable communications unit may be a Wireless Local Area Network Card.

Suitably, the removable communications unit may have an encoder coupled to said processor. There may also be a decoder coupled to said processor.

Preferably, the removable communications unit has an antenna stub and the unit communications port may be mounted to the stub.

Suitably, the unit communications port may allow the security information to be transferred only when the proximity based communications port is in direct contact therewith.

Preferably, in use, the security information allows the removable communications unit to become part of a federation of operable communications units.

Suitably, in use, the security information is an encryption key that allows the removable communications unit to encode and decode signals and thereby communicate with other operable communications units that have the same key.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic view of a federation of devices in accordance with the present invention;

FIG. 2 is a schematic diagram of an introduction device and removable communications unit that is coupled electrically to one of the devices of FIG. 1 in accordance with the present invention;

FIG. 3 illustrates a method for creating a federation of devices in accordance with an embodiment of the present invention;

FIG. 4 is schematic block diagram of the introduction device of FIG. 2 in accordance with the present invention; and

FIG. 5 is an enlarged, partial perspective view of one embodiment of a communications port of the introduction device of FIG. 4 and a communications port of the removable communication unit of FIG. 2.

### DETAILED DESCRIPTION OF THE PREFERRED EMBODIMENT OF THE INVENTION

In the drawings, like numerals on different Figs are used to indicate like elements throughout. The present invention uses proximity based information exchange mechanisms to transfer a shared secret between multiple devices and gateways that then allows the devices to communicate with one another over either wired or wireless links in a secure manner. If the shared secret is not established then the devices or appliances cannot communicate with each other.

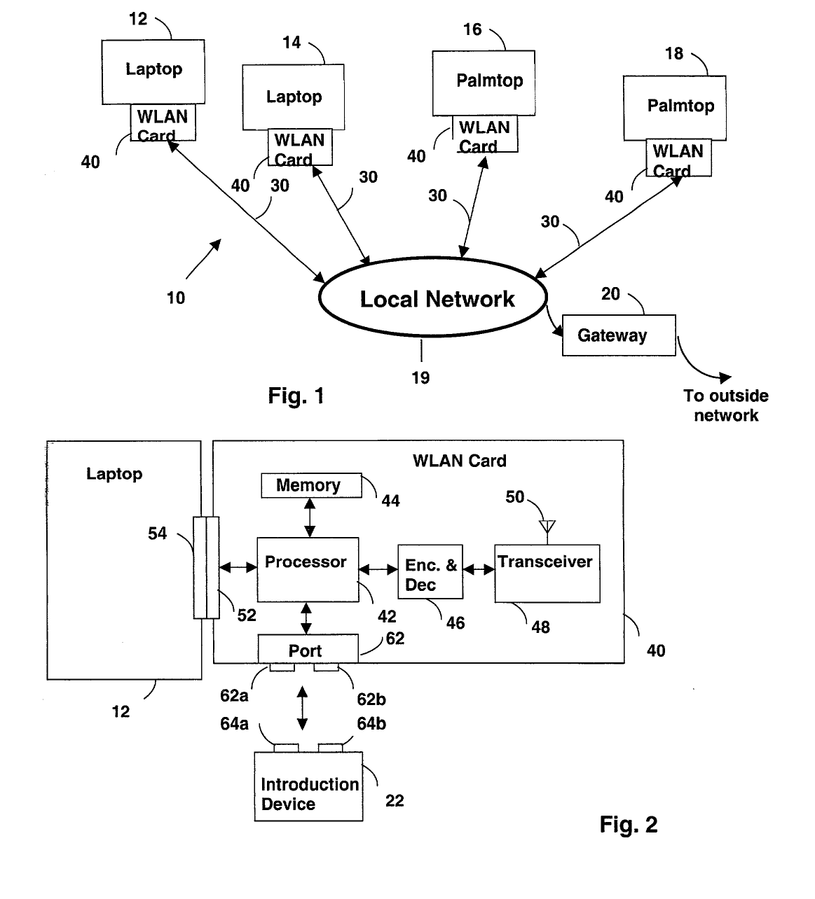

Referring to FIG. 1, an example of a federation of devices 10 is shown. The federation of devices 10 includes a laptop computers 12,14 and palmtop computers 16,18 each having a removable communications unit typically in the form of a Wireless Local Area Network Card (WLAN Card) 40 coupled electrically thereto. Each WLAN Card 40 is connected to a local network 19 by radio links 30. The local network 19 has an associated gateway 20 and the network allows the devices 12-18 to communicate, through their WLAN Card 40, with each other or with other devices (not shown) on an outside network via the gateway 20. For example, a personal computer connected to a network such as the Internet could access the federation of devices 10 via the gateway 20. Although a gateway 20 is included in the federation shown in FIG. 1, it will be understood by those of ordinary skill in the art that a gateway is not required. That is, federations of devices can be formed without a gateway being present. Each of the devices 12-18 are understood by those of skill in the art and a detailed discussion thereof is not required for those of skill in the art to understand the present invention.

In this example, the devices 12-18 are each connected to the local network 19. The gateway 20 provides a communications link between the federation of devices 10 and other devices coupled to an outside network. The gateway 20 can be a modem, such as a cable modem, a telephone modem, or other communications device that provides a communications link to outside networks.

Referring to FIG. 2 there is illustrated an introduction device 22 and the WLAN Card 40 that is coupled electrically to one of the electronic devices of the federation of devices (in the example laptop computer 12). The WLAN Card 40 comprises a processor 42 coupled to a non-volatile memory 44. The processor 42 is also coupled to a communications port 62, a combined encoder and decoder 46 and a unit connector 52 that allows for complementary releasable engagement of a device connector 54 associated with the laptop computer 12. The connectors 52,52 allow communication between the processor 42 and the laptop computer 12. Coupled to the processor 42 through the encoder/decoder 46 is a combined transmitter and receiver in the form of a transceiver 48 that has an associated antenna 50. The communications port 62 has two communication links in this embodiment these links are a receive link 62a and a transmit link 62b that are able to communicate with respective a complementary transmit link 64a and a receive link 64b of the introduction device 22.

As will be apparent to a person skilled in the art, when the connectors 52,54 are engaged then most of the WLAN Card 40 is enclosed by a housing of the laptop computer 12. However, a stub enclosing the antenna 50 protrudes outside the housing of the laptop computer 12. Accordingly, for easy access, the unit communications port 62 is mounted to the stub. Further, the transceiver and associated antenna 50 allows the WLAN card 40 to communicate with at least one other operative WLAN card 40 by radio frequency signals (radio links 30) and the local network 19.

A federation of devices is created by establishing a secure communications channel between the introduction device 22 and the WLAN Card 40 that is releasably engaged with the laptop 12. The introduction device 22 may be purpose built or it may be part of a portable handheld device such as a mobile telephone, a personal digital assistant (PDA) or any other portable computing device.

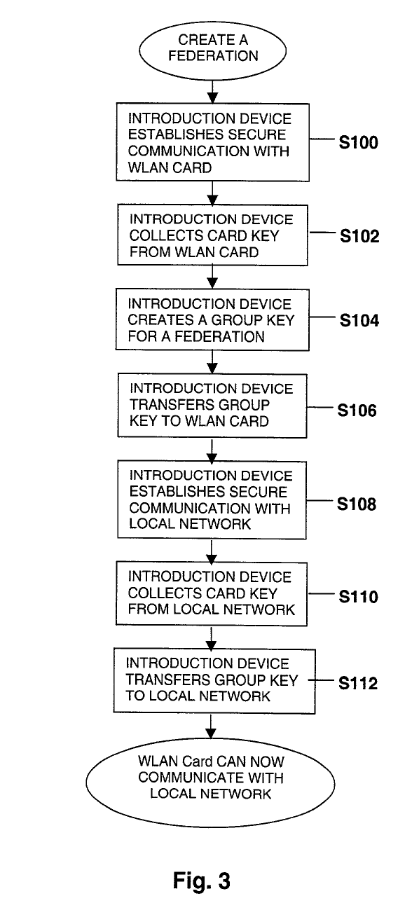

Referring to FIG. 3, there is illustrated a method for creating a federation of devices. In step S100, the introduction device 22 establishes a secure communications channel with the WLAN Card 40. A secure communications channel may be established through the use of cryptographic techniques like Diffie-Hellman key agreement. However, as discussed in more detail below, it is preferred that a secure channel is formed by placing the introduction device 22 in aligned close proximity to the WLAN Card 40 and then using a short range wireless infrared protocol or by placing the introduction device 22 in direct contact with the communications port 62 of WLAN Card 40. The close proximity or direct contact between the introduction device 22 and the communications port 62 increases key exchange security significantly as interception of communication is difficult as low power transmissions can be used for key exchanging.

In step S102, the introduction device 22 collects a card key from the WLAN Card 40. Card keys can be stored in the memory 44 within the WLAN Card 40 or attached to a storage medium on the appliance 26 such as an RFID (radio frequency identification) tag or a barcode. Alternatively, a card key could be generated by the introduction device 22 itself and then transferred to the WLAN Card 40 for storage in the memory 44. The card key is collected from the WLAN Card 40 so that the introduction device 22 can later communicate with the WLAN Card 40 in a secure manner using known cryptographic techniques without the need for using the proximity based secure channel. Further, per-card keys allow re-keying of remaining WLAN Cards 40 to take place when a WLAN Card 40 possessing a group key is removed from a federation.

Next, in step S104, the introduction device 22 generates security information for the federation, such as a group key, per-device cryptographic keys, and access control information. Alternatively, the WLAN Card 40 could generate the security information for the federation or the security information could be generated by a separate device such as a personal or notebook computer and then stored in either the introduction device.

In step S106, the introduction device 22 transfers the security information to the WLAN Card 40 via the secure communications channel. It will be understood by those of skill in the art that the steps may be performed in an order other than that shown in FIG. 3. For example, although step S104 is shown as occurring after steps S100, S102, step S104 could occur anywhere before step S106. Similarly, step S102 could occur after step S106. In the presently preferred embodiment, step S104 occurs before step S100.

In step S108 the introduction device 22 is then connected to securely communicate with a second WLAN Card 40 that is, for instance, coupled electrically to laptop computer 14. Again, in the presently preferred embodiment, the introduction device 22 is placed in close proximity to the communications port 62 of the second WLAN Card 40 and more preferably, is placed in direct contact with the second WLAN Card 40 in order to establish a secure communications channel between the introduction device 22 and the second WLAN Card 40 (similar to that discussed in step S110). Once a secure communications channel is established, in step S112 the security information, such as the federation group key is transferred from the introduction device 22 to the second WLAN Card 40. Thereafter, both of the WLAN Cards 40 are members of the same federation and can communicate with each other in a secure manner using the local network 19. Adding further appliances to the federation only requires that the security information be transferred between the introduction device 22 and the WLAN Card 40. Existing members of the federation are not involved. Once the new WLAN Card 40 has the security information for the federation, the new WLAN Card 40 can communicate with any operative WLAN Card 40 in the federation. Further, because the WLAN Cards 40 are removable and interchangeable with any suitable device such as devices 12-18, security is improved and when for instance WLAN Card 40 is coupled to palmtop 18 then the WLAN Card 40 allows palmtop 18 to be part of the federation. The invention concerns the use of establishing a secure communications channel or alternatively providing secure transfer of keys including pseudo random number generator seeds used by the encoder/decoder 46. When a seed is provided to the WLAN Card 40, by the introduction device 22, the encoder/decoder 46 can then encrypt and decrypt data that is used in communicating with other units that also have the same seed.

The introduction device 22 can also introduce the WLAN Card 40 into a number of federations at the same time by transferring an appropriate group key or by transferring multiple group keys from the introduction device 22.

In order to delete or remove a WLAN Card 40 from a federation, the introduction device 22 overwrites or erases the federation group key stored in that appliance. Another way of removing an appliance from a federation is, for example, to introduce the WLAN Card 40 into a new federation by overwriting it's group key with a new group key, thereby breaking communication with the previous federation.

Alternatively, a new group key can be provided to the federation except for the WLAN Card 40 to be removed. Removing a WLAN Card 40 from a federation by changing the security information on all of the devices except for the device to be removed from the federation need not be done with a secure channel, since the introduction device 16 can use the device keys collected in step S102 to protect the new group key during transmission to each device in the federation. The WLAN Card 40 to be removed is not sent a copy of the new key, thus preventing it from eavesdropping on traffic sent between members of the federation in the future.

The introduction device 22 can also be used to copy part or all of the security information collected in step S102 to another WLAN Card 40, such as a computer system with secure backup storage, or another introduction device so that a failure of the introduction device 22 is not catastrophic and does not require all devices to be re-introduced to each other.

In the same manner that a federation is created, a new WLAN Card 40 may be added to an existing federation of appliances by placing the introduction device 22 in close proximity to the new WLAN Card 40 to establish a secure communications channel between the new appliance and the introduction device 22 (e.g., step S108) and transferring security information of the federation from the introduction device 22 to the new WLAN Card 40. The introduction device 22 preferably also collects a card key from the new appliance after it establishes a secure communications channel with the new WLAN Card 40.

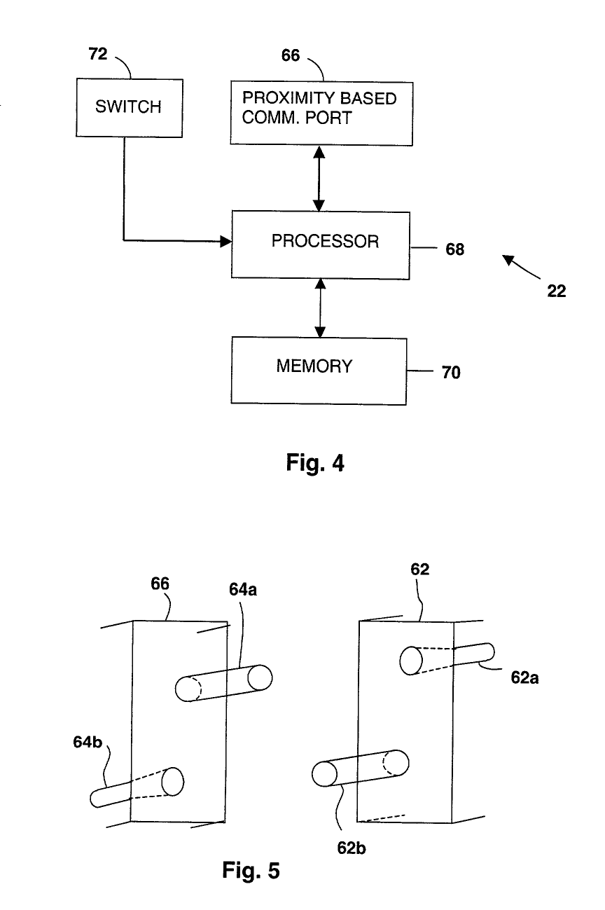

Referring now to FIG. 4, a schematic block diagram of the introduction device 22 according to one embodiment of the present invention is shown. The introduction device 22 is designed for assigning a WLAN Card 40 to a federation of WLAN Cards 40 in a secure manner. Rather than relying on the transmission of encrypted data, it is preferred to use a proximity based secure transmission system. However, although the use of proximity and secret propagation using proximity are the basis for the invention, it will be understood by those of ordinary skill in the art that cryptographic protocols may be used in addition to the proximity solution.

The introduction device 22 includes a proximity based communications port 66 that permits secure transfer of information, between a WLAN Card 40 and the introduction device 22, when the proximity based communications port 66 is placed in close proximity to the unit communications port 62 of the WLAN Card 40. The communications port 66 may be an infrared port, a very short-range wireless port, a bi-static port, a combined image projector and camera or a contact based port.

A processor 68 is connected to the proximity based communications port 66. A memory 70 is connected to the processor 68 for storing security information, such as per-card keys, federation or group keys, and other access control information. The memory 70 may be a nonvolatile memory and preferably is a RAM. The memory 70 may be separate from or integral with the processor 68.

Preferably a switch 72 is connected to the processor 54 for signalling the processor 68 to communicate with a WLAN Card 40 that has been placed in close proximity to the communications port 66. Activation of the switch 72 signals the processor 68 to transfer the security information between the WLAN Card 40 and the device 22 via the proximity based communications port 66. In other words, the switch 72 causes the processor 68 to perform the aforementioned method of introducing a new WLAN Card 40 to a federation or removing a WLAN Card 40 from a federation or securely transferring encryption keys to and from the WLAN Card 40. The switch 72 may be a contact type switch connected directly to the processor 68 or connected to the processor 68 via the proximity based communications port 66. Further, the switch 72 may be a sensor that is integral with the port 66 such that when the unit communications port 62 of a WLAN Card 40 is placed in contact with the port 66, the switch 72 is automatically activated. The switch 72 could also be implemented in software. An alternative to the switch 72 would be to have the device 50 either continuously or periodically attempt to perform the aforementioned introduction method.

Referring now to FIG. 5, one embodiment of a portion of the proximity based communications port 66 is shown along with the unit communications port 62 of the WLAN Card 40. As can be seen, the communications ports 66, 62 are mirror images. Each of the ports 66, 62 includes a respective transmit side connector 64a, 62b and a respective receive side connector 64b, 62a. The transmit side connector 64a transmits data (keys) to the receive side connector 62a and the transmit side connector 62b transmits data (keys) to the receive side connector 64b. In this embodiment, the transmit side connectors 64a, 62b are designed to be received by the receive side connectors 62a,64b respectively. That is, the connectors 64a, 64b are generally cone shaped spigots and project out from the port 66 while the connectors 62a, 62b are openings (sockets) sized to receive the connectors 64a, 64b. When the connector 64a is inserted into the connector 62a, if the connector is a light based connector, then light does not escape or leak out of the receiving connector 62a. The connectors 62b, 64b mate in a similar manner. Thus, it can be seen that such mating connectors provide a secure interface and security information transmitted between the device 22 and the WLAN Card 40 is secure. The communications ports may be required to physically contact or touch each other or just be very close to each other, depending on the communications technology (wired, light based, RF, etc.) used, so long as a secure transmission is provided. The touching may be detected by having a button on each device that must be depressed and released at the same time. It should also be noted that the communications port 62 may be a barcode reader, finger print reader, a combined image projector and camera or any receiver capable of at least receiving a key.

From the foregoing, it can be seen that the introduction device of the present invention introduces third-party devices to each other. The device is analogous to a person who introduces two strangers to each other. The introduction device is used to establish a secure channel with each device in turn, and transfer security information that allows the devices to communicate securely with each other over an untrusted network. As previously discussed, the security information that the introduction device transfers to third party devices includes per-device cryptographic keys, access control information, and group keys.

Advantageously, the present invention allows a user to temporarily connect the WLAN Card 40 to any suitable electronic device. Since the WLAN Card 40 has a key allowing communication with one or more federations, then there is no need for the device to store key. Accordingly, the user can simply disconnect the WLAN Card 40 after use and later connect the WLAN Card 40 to another device, and again communicate with the federation, without being concerned with the possibility of the device does not have the key.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A removable communications unit comprising:
a unit communications port that permits secure transfer of information between the removable communications unit and an introduction device when a proximity based communications port of the introduction device is placed in close proximity to the unit communications port;
a processor connected to the unit communications port;
a unit connector that allows for complementary releasable engagement of a connector associated with an electronic device, the unit connector being connected to the processor and allows communication between the processor and the electronic device;
a communications interface connected to the processor for allowing the removable communications unit to communicate with at least one other remote removable communications unit; and
a memory connected to the processor for storing security information, wherein in use the processor communicates with the introduction device to transfer the security information between the memory and introduction device via the unit communications port and the proximity based communications port.

2. A removable communications unit as claimed in claim 1, wherein the unit communications port allows the security information to be transferred from the introduction device to the memory.

3. A removable communications unit as claimed in claim 1, wherein the unit communications port allows security information to be transferred from the memory to the introduction device.

4. A removable communications unit as claimed in claim 1, wherein the communications interface is a transmitter, receiver or transceiver.

5. A removable communications unit as claimed in claim 1, wherein the communications interface communicates with at least one said other remote removable communications unit by radio frequency signals.

6. A removable communications unit as claimed in claim 5, wherein the removable communications unit is a Wireless Local Area Network Card.

7. A removable communications unit as claimed in claim 1, wherein the removable communications unit has an encoder coupled to said processor.

8. A removable communications unit as claimed in claim 1, wherein there is a decoder coupled to said processor.

9. A removable communications unit as claimed in claim 1, further including an antenna stub and the unit communications port is mounted to the stub.

10. A removable communications unit as claimed in claim 1, wherein the unit communications port allows the security information to be transferred only when the proximity based communications port is in direct contact therewith.

11. A removable communications unit as claimed in claim 1, wherein, in use, the security information allows the removable communications unit to become part of a federation of operable communications units.

12. A removable communications unit as claimed in claim 1, wherein, in use, the security information is an encryption key that allows the removable communications unit to encode and decode signals and thereby communicate with other operable communications units that have the same key.
